(19) United States
(12) Patent Application Publication
(10) Pub. No.: US 2018/0050937 A1
(43) Pub. Date: Feb. 22, 2018

(54) AXIAL INFUSER ASSEMBLY

(71) Applicant: James Bruce Schroeder, Leipsic, OH (US)

(72) Inventor: James Bruce Schroeder, Leipsic, OH (US)

(21) Appl. No.: 15/660,171

(22) Filed: Jul. 26, 2017

Related U.S. Application Data
(60) Provisional application No. 62/376,592, filed on Aug. 18, 2016.

(51) Int. Cl. C02F 1/68; B01F 3/08; B01F 5/04; B01F 5/02

(52) U.S. Cl. CPC C02F 1/686; B01F 3/0865; B01F 5/0461; B01F 2215/0052; B01F 5/0206; B01F 5/0471; B01F 5/0456

(57) ABSTRACT

An axial infuser assembly for use in a water treatment system is provided. The axial infuser assembly includes a first segment in fluid communication with a first inlet pipe. The first segment is further configured to receive a slurry flow. A second segment is in fluid communication with the first segment and is connected to an outlet pipe. The second segment receives the slurry flow from the first segment. A third segment is connected to the first and second segments and is also connected to a second inlet pipe. The third segment receives a motive flow. A jet assembly is in fluid communication with the third segment and conveys the motive flow in the third segment to the slurry flow. The motive flow exiting the jet assembly is configured to infuse with the slurry flow and further configured to urge the slurry flow into flowing raw, untreated water.

### RELATED APPLICATIONS

This application claims priority from pending U.S. Provisional Patent Application No. 62/376,592 filed Aug. 18, 2016, the disclosure of which is incorporated herein by reference in its entirety.

### BACKGROUND

Municipal water authorities are charged with the task of providing clean drinking water. Water treatment plants are often established and configured to bring in raw, untreated water and process the raw, untreated water through one or more production processes to form purified, potable water.

In certain purifying production processes, desired elements and/or chemicals can be added to the raw, untreated water. Non-limiting examples of added elements and/or chemicals include carbon, soda ash and lime. In certain instances, prior to adding the elements and/or chemicals to the raw, untreated water, a slurry is formed by the addition of the elements and/or chemicals to a flowable medium, such as for example water. The resulting slurry is then inserted into the raw, untreated water for purposes of treating the raw, untreated water.

In other instances, the elements and/or chemicals include carbon, soda ash and lime can be inserted into the raw, untreated water without the flowable medium, that is, the elements and/or chemicals are added to the raw, untreated water in a “dry” form.

To be effective, the elements and/or chemicals are inserted into the raw, untreated water in desired concentrations. The desired concentrations are designed to optimize the purification of the raw, untreated water within other production measures.

It would be advantageous if the insertion of the elements and/or chemicals into raw, untreated water could be accomplished in a more efficient manner.

### SUMMARY

It should be appreciated that this Summary is provided to introduce a selection of concepts in a simplified form, the concepts being further described below in the Detailed Description. This Summary is not intended to identify key features or essential features of this disclosure, nor is it intended to limit the scope of the programmable locking dispenser.

The above objects as well as other objects not specifically enumerated are achieved by an axial infuser assembly configured for use in a water treatment system. The axial infuser assembly includes a first segment configured for fluid communication with a first inlet pipe. The first segment is further configured to receive a slurry flow. A second segment is in fluid communication with the first segment and is configured for connection to an outlet pipe. The second segment is configured to receive the slurry flow from the first segment. A third segment is connected to the first and second segments and is configured for connection to a second inlet pipe. The third segment is configured to receive a motive flow. A jet assembly is in fluid communication with the third segment and is configured to convey the motive flow in the third segment to the slurry flow. The motive flow exiting the jet assembly is configured to infuse with the slurry flow and further configured to urge the slurry flow into flowing raw, untreated water.

There is also provided a method of operating an axial infuser assembly configured for use in a water treatment system. The method including the steps of receiving a slurry flow within an axial infuser assembly, receiving a motive flow within the axial infuser assembly, injecting the motive flow into the slurry flow with a jet assembly positioned within the axial infuser assembly such that the motive flow is infused into the slurry flow and conveying the combination of the slurry flow and the motive flow downstream for injection of the combination of the slurry flow and the motive flow into raw, untreated water.

There is also provided a water treatment system incorporating an axial infuser assembly. The water treatment system includes a first inlet pipe configured to convey a slurry flow and a second inlet pipe configured to convey a motive flow. An axial infuser assembly is in fluid communication with the first inlet pipe and the second inlet pipe. The axial infuser assembly is further configured to receive the slurry flow from the first inlet pipe and a motive flow from the second inlet pipe. The axial infuser assembly includes a jet assembly in fluid communication with the second inlet pipe and is configured to convey the motive flow to the slurry flow. An outlet pipe is configured to receive the slurry flow and the motive flow exiting the axial infuser assembly and convey the slurry flow and the motive flow downstream. A header is configured to receive the slurry flow and the motive flow exiting the outlet pipe and mix the slurry flow and the motive flow with flowing raw, untreated water.

There is also provided a method of operating a water treatment system incorporating an axial infuser assembly. The method includes the steps of forming a slurry flow having a desired concentration of elements suspended in a flowable medium, conveying the slurry flow to an axial infuser assembly, conveying a motive flow to the axial infuser assembly, the motive flow having a desired pressure and flow rate, injecting the motive flow into the slurry flow with a jet assembly positioned within the axial infuser assembly such that the motive flow is infused into the slurry flow, conveying the combination of the slurry flow and the motive flow with an outlet pipe to a header and injecting the combination of the slurry flow and the motive flow into raw, untreated water flowing in the header.

Various objects and advantages of the axial infuser assembly will become apparent to those skilled in the art from the following detailed description, when read in light of the accompanying drawings.

### BRIEF DESCRIPTION OF THE DRAWINGS

FIG. 1 is a front view, in elevation, of a first embodiment of an axial infuser assembly.

FIG. 2 is a right side view, in elevation, of the axial infuser assembly of FIG. 1.

FIG. 3 is a bottom view, in elevation, of the axial infuser assembly of FIG. 1.

FIG. 4 is a left side view, in elevation, of the axial infuser assembly of FIG. 1.

FIG. 5 is a front sectional view, in elevation, of the axial infuser assembly of FIG. 1.

FIG. 6A is a side view, in elevation, of a first embodiment of a jet assembly of the axial infuser assembly of FIG. 1.

FIG. 6B is a side view, in elevation, of a second embodiment of a jet assembly of the axial infuser assembly of FIG. 1.

FIG. 7 is a perspective view of the axial infuser assembly of FIG. 1 shown in an installed position.

FIG. 8 is a schematic illustration of the operation of the axial infuser assembly of FIG. 1.

FIG. 9 is a schematic illustration of the operation of the second embodiment of an axial infuser assembly.

FIG. 10 is a schematic illustration of a third embodiment of an axial infuser assembly.

FIG. 11 is a schematic illustration of a fourth embodiment of an axial infuser assembly.

FIG. 12 is a right side view, in elevation, of the axial infuser assembly of FIG. 11.

FIG. 13 is a right side view, in elevation, of an alternate embodiment of the axial infuser assembly of FIG. 11.

### DETAILED DESCRIPTION

The axial infuser assembly will now be described with occasional reference to specific embodiments. The axial infuser assembly may, however, be embodied in different forms and should not be construed as limited to the embodiments set forth herein. Rather, these embodiments are provided so that this disclosure will be thorough and complete, and will fully convey the scope of the axial infuser assembly to those skilled in the art.

Unless otherwise defined, all technical and scientific terms used herein have the same meaning as commonly understood by one of ordinary skill in the art to which the axial infuser assembly belongs. The terminology used in the description of the axial infuser assembly herein is for describing particular embodiments only and is not intended to be limiting of the axial infuser assembly. As used in the description of the axial infuser assembly and the appended claims, the singular forms “a,” “an,” and “the” are intended to include the plural forms as well, unless the context clearly indicates otherwise.

Unless otherwise indicated, all numbers expressing quantities of dimensions such as length, width, height, and so forth as used in the specification and claims are to be understood as being modified in all instances by the term “about.” Accordingly, unless otherwise indicated, the numerical properties set forth in the specification and claims are approximations that may vary depending on the desired properties sought to be obtained in embodiments of the axial infuser assembly. Notwithstanding that the numerical ranges and parameters setting forth the broad scope of the axial infuser assembly are approximations, the numerical values set forth in the specific examples are reported as precisely as possible. Any numerical values, however, inherently contain certain errors necessarily resulting from error found in their respective measurements.

The description and figures disclose an axial infuser assembly. Generally, the axial infuser assembly is configured to urge a slurry flow, formed from elements and/or chemicals and mixed with a flowable medium, into flowing raw, untreated water. The slurry is configured to mix with the flowing raw, untreated water such that the elements and/or chemicals within the slurry mix with the flowing raw, untreated water and have the desired purifying effect.

The term “raw, untreated water”, as used herein, is defined to mean any water that has not been examined, properly treated, and not approved by appropriate authorities as being safe for consumption. The term “slurry”, as used herein, is defined to mean a mixture of an insoluble substance with a liquid. The term “axial”, as used herein, is defined to mean characterized by an axis.

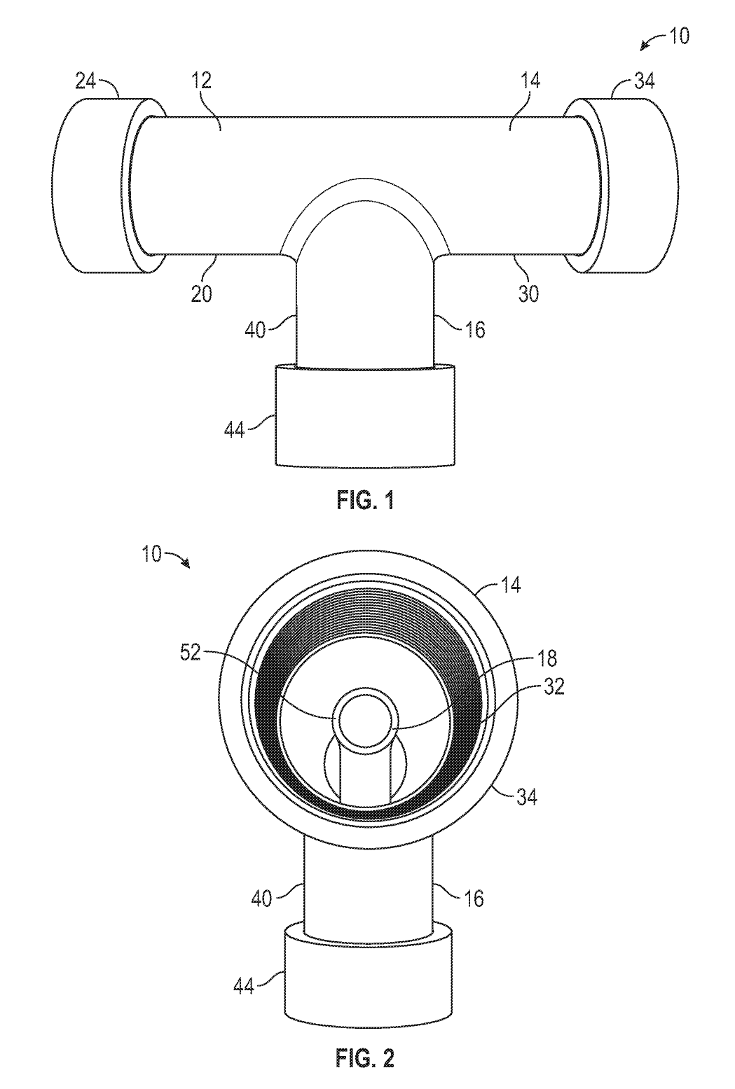

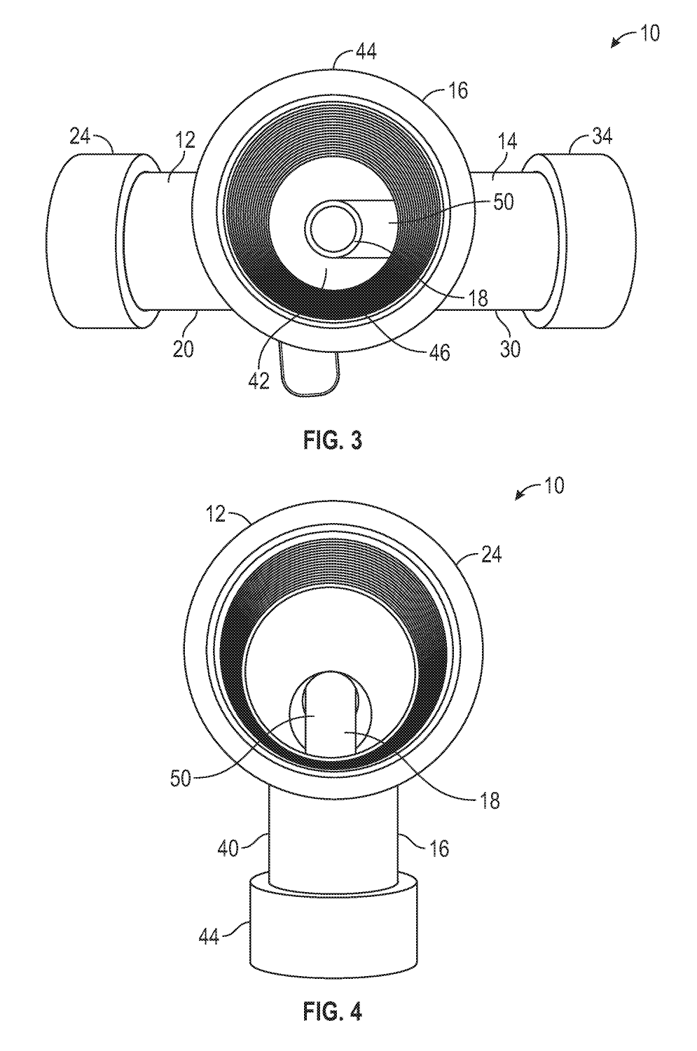

Referring now to FIGS. 1-5, a first non-limiting embodiment of an axial infuser assembly is shown schematically at 10. The axial infuser assembly 10 is configured to receive a slurry flow and efficiently urge the slurry flow into a structure having a flow of raw, untreated water.

The axial infuser assembly 10 includes a first segment 12, a second segment 14, a third segment 16 and a jet assembly 18.

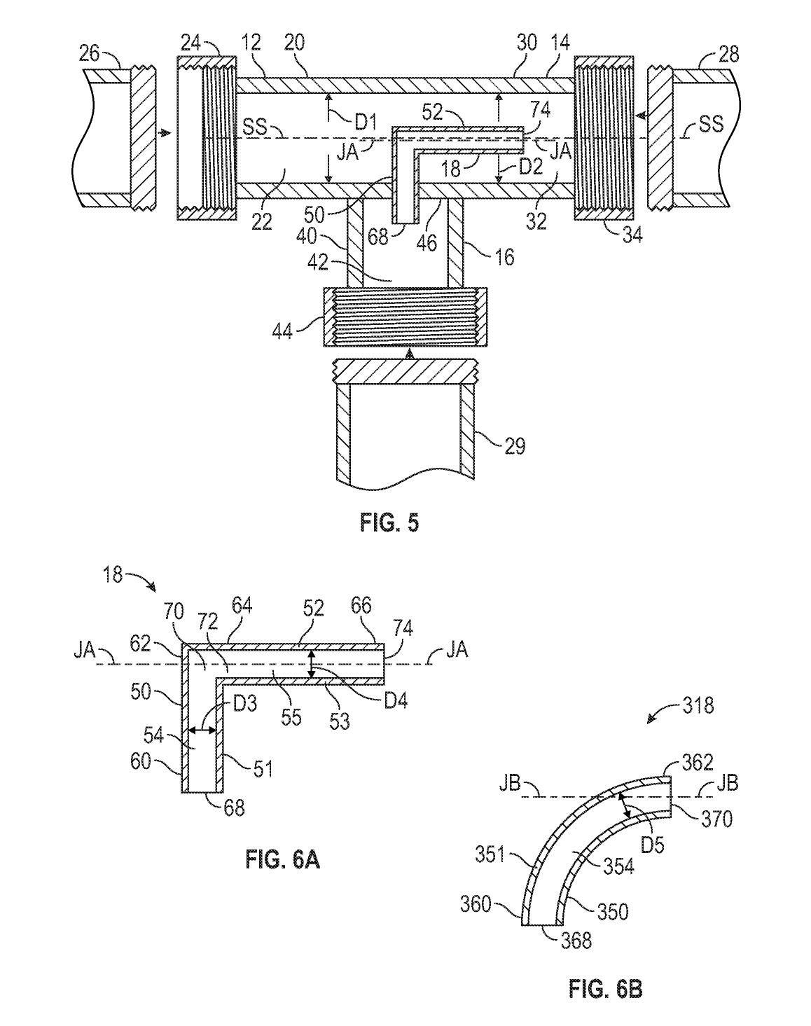

Referring again to FIGS. 1-5, the first segment 12 includes a first circumferential wall 20 defining a first internal passage 22 and a first coupling 24. The first internal passage 22 is configured to receive a slurry flow and convey the slurry flow to the second segment 14 of the axial infuser assembly 10. The first coupling 24 is configured for threaded connection to a first inlet pipe 26 (FIG. 5). In the illustrated embodiment, the first coupling 24 is internally threaded such as to receive a threaded portion of the first inlet pipe 26. Although in other embodiments, the first coupling 24 can have other configurations sufficient for connection to the first inlet pipe 26.

Referring again to FIGS. 1-5, the second segment 14 is in fluid communication with the first segment 12 and includes a second circumferential wall 30 defining a second internal passage 32 and a second coupling 34. The second internal passage 32 is configured to receive a slurry flow exiting the first internal passage 22 of the first segment 12 and further configured to convey the slurry flow through the second segment 14 and out of the axial infuser assembly 10. The second internal passage 32 is further configured to receive a portion of the jet assembly 18. The jet assembly 18 will be discussed in more detail below. The second coupling 34 is configured for threaded connection to an output pipe 28 (FIG. 5). In the illustrated embodiment, the second coupling 34 is internally threaded such as to receive a threaded portion of the outlet pipe 28. Although in other embodiments, the second coupling 34 can have other configurations sufficient for connection to the output pipe 28.

Referring again to FIGS. 1-5, the third segment 16 includes a third circumferential wall 40 defining a third internal passage 42, a third coupling 44 and an internal wall 46. The third internal passage 42 is configured to receive a motive flow (not shown) and convey the motive flow to the jet assembly 18. The motive flow and the jet assembly 18 will be discussed in more detail below. The third coupling 44 is configured for connection to a motive flow input pipe 29 (FIG. 5). In the illustrated embodiment, the third coupling 44 is internally threaded such as to receive a threaded portion of the motive flow inlet pipe 29. Although in other embodiments, the third coupling 44 can have other configurations sufficient for connection to a motive flow input pipe 29. The internal wall 46 extends radially from the jet assembly 18 to the third circumferential wall 40 and is configured to block the motive flow from passing from the third internal passage 42 of the third segment 16 to the first and second internal passages 22, 32 of the first and second segments 12, 14.

In the embodiment illustrated in FIGS. 1-5, the first, second and third segments 12, 14 and 16 have a circular cross-sectional shape. However, it should be appreciated that in other embodiments, the first, second and third segments 12, 14 and 16 can have non-circular cross-sectional shapes.

Referring now to FIG. 5, the first segment and second segments 12, 14 are formed from nominal 2.00 inch pipe and the first internal passage 22 has a first diameter D1 and the second internal passage 32 has a second diameter D2. In the illustrated embodiment, the diameters D1, D2 are the same and are about 1.88 inches. However, in other embodiments, the first and second segments can be formed from pipes having other sizes and the diameters D1, D2 can be different from each other and can be more or less than about 1.88 inches. The diameters D1, D2 form cross-sectional areas of the first and second internal passages 22, 32. In the illustrated embodiment, the cross-sectional areas of the first and second internal passages 22, 32 are about 2.8 square inches. Alternatively, in other embodiments the cross-sectional areas of the first and second internal passages 22, 32 can be more or less than about 2.8 square inches. The cross-sectional areas of the first and second internal passages 22, 32 will be discussed in more detail below.

Referring now to FIGS. 5 and 6A, a first embodiment of the jet assembly 18 is illustrated. The jet assembly 18 extends from the internal wall 46 and is configured to convey the motive flow received in the third segment 16 to the second internal passage 32 of the second segment 14. The jet assembly 18 has a first jet segment 50 and a second jet segment 52. The first and second jet segments 50, 52 include outer walls 51, 53 respectively. The outer wall 51 of the first jet segment 50 defines a fourth internal passage 54 extending the length of the first jet segment 50 and the outer wall 53 of the second jet segment 52 defines a fifth internal passage 55 extending the length of the second jet segment 50. In the illustrated embodiment, the first and second jet segments 50, 52 form hollow structures having circular cross-sectional shapes. In alternate embodiments, the first and second segments 50, 52 can form other structures and can have non-circular cross-sectional shape.

Referring again to FIGS. 5 and 6A, the first jet segment 50 has a first end 60 and a second end 62. Similarly, the second jet segment 52 has a first end 64 and a second end 66. The first end 60 of the first jet segment 50 includes a first jet aperture 68 and the second end 62 of the first jet segment 50 includes a second jet aperture 70. The first end 64 of the second jet segment 52 includes a third jet aperture 72 and the second end 66 of the second jet segment 52 includes a fourth jet aperture 74. The first jet aperture 68 is in fluid communication with the third internal passage 42 of the third segment 16 and is further configured to receive the motive flow contained within the third segment 16.

Referring again to FIGS. 5 and 6A, the second end 62 of the first jet segment 50 and the first end 62 of the second jet segment 52 are connected together such that the second jet aperture 70 of the first jet segment 50 and the first jet aperture 72 of the second jet segment align and are in fluid communication with each other such that the motive flow received by the first jet aperture 68 can flow through the first jet segment 50 and into the second jet segment 52.

Referring again to FIGS. 5 and 6A, the fourth aperture 74 of the second jet segment 52 is in fluid communication with the second internal passage 32 of the second segment 14 such that motive flow received by the second jet segment 52 exits the fourth jet aperture 74 and flows into the second internal passage 32.

Referring now to FIG. 6A, the first and second jet segments 50, 52 are formed from nominal 0.50 inches pipe. However, in other embodiments, the first and second jet segments can be formed from pipe having other dimensions. The fourth internal passage 54 of the first jet segment 50 has a first diameter D3 and the fifth internal passage 55 has a second diameter D4. In the illustrated embodiment, the diameters D3, D4 are the same and are about 0.44 inches. However, in other embodiments, the diameters D3, D4 can be different from each other and can be more or less than about 0.44 inches. The diameters D3, D4 form a cross-sectional area of the fourth and fifth internal passages 54, 55. In the illustrated embodiment, the cross-sectional areas of the fourth and fifth internal passages 54, 55 are about 0.15 square inches. However, in other embodiments, the cross-sectional area of the fourth and fifth internal passages 54, 55 can be more or less than about 0.15 square inches. The cross-sectional areas of the fourth and fifth internal passages 54, 55 of the first and second jet segments 50, 52 will be discussed in more detail below.

Referring again to FIG. 6A, the second jet segment 52 of the jet assembly 18 is radially centered about longitudinal axis JA-JA. Referring now to FIG. 5, the first and second internal passages 22, 32 of the first and second segments 12, 14 are radially centered about longitudinal axis SS-SS. In the illustrated embodiment, the longitudinal axes SS-SS and JA-JA are arranged to be substantially parallel, such that the motive flow exiting the fourth jet aperture 74 of the jet assembly 18 flows in the same direction with the slurry flow in the second segment 14 of the axial infuser assembly 10. As the motive flow flows in the same direction with the slurry flow in the second segment 14 of the axial infuser assembly 10, the motive flow is infused into the slurry flow.

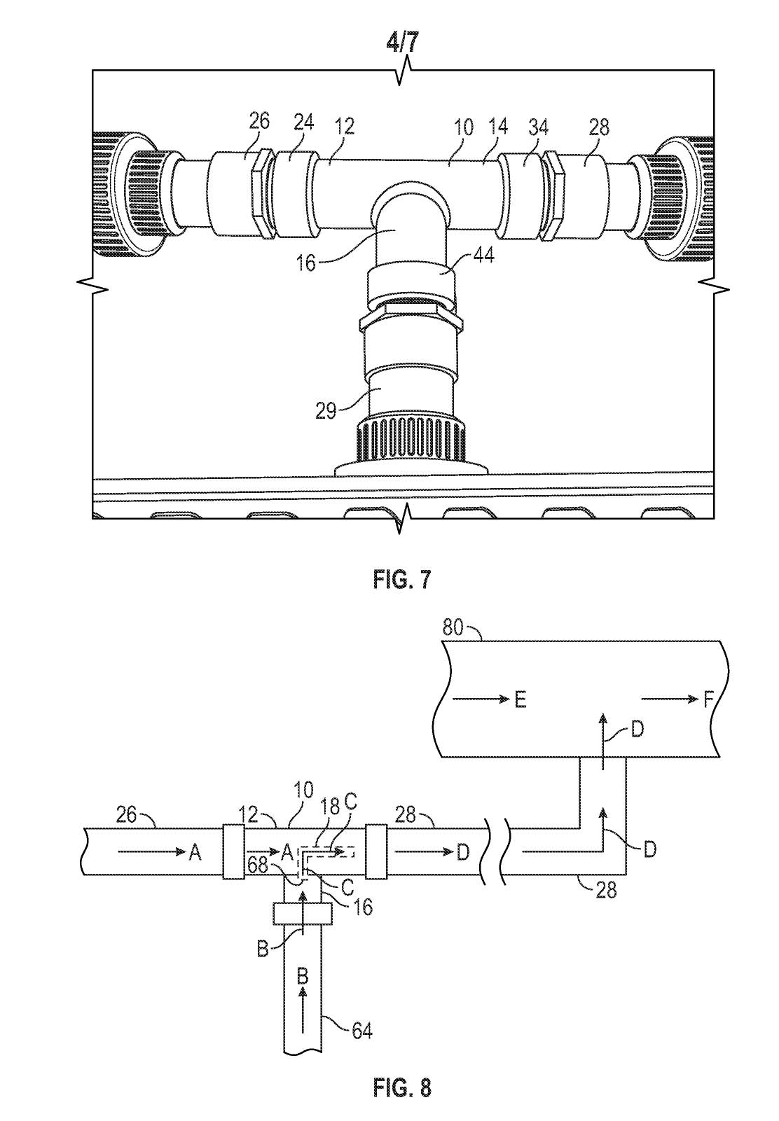

Referring now to FIG. 7, the axial infuser assembly 10 is shown in an installed position. The first coupling 24 of the first segment 12 is connected to the first inlet pipe 26, the second coupling 34 of the second segment 14 is connected to the outlet pipe 28 and the third coupling 44 of the third segment 16 is connected to the motive flow input pipe 29.

Referring now to FIG. 8, operation of the axial infuser assembly 10 will now be described. The first segment 12 of the axial infuser assembly 10, connected to the first inlet pipe 26, receives the slurry flow as characterized by direction arrows A. The slurry flow is configured for mixing with raw, untreated water as a purification treatment. In the illustrated embodiment, the slurry flow is a mixture of water and elements and/or chemicals, including the non-limiting examples of carbon, soda ash and/or lime. Alternatively, the slurry flow can be a mixture of other desired elements. The slurry flow can have any desired concentration level of the elements and/or chemicals within the water. As one non-limiting example, in the illustrated embodiment, the concentration level is 12.0%, as achieved by a mixture including one pound of carbon with one gallon of water. However, other concentration levels can be used.

Referring again to FIG. 8, the third segment 16 of the axial infuser assembly 10, connected to the motive flow input pipe 29, receives the motive flow as characterized by direction arrows B. As the motive flow flows through the third segment 16, a portion of the motive flow contacts the third internal wall 46 and is prevented from further flow. Another portion of the motive flow is received by the first jet aperture 68 and continues to flow through the jet assembly 18 as characterized by direction arrows C. The motive flow continues to flow through the jet assembly 18 and exits the jet assembly 18 through the fourth jet aperture 74.

Referring again to FIG. 8, the motive flow is configured for infusing with the slurry flow and further configured to urge the slurry flow into flowing raw, untreated water. In the illustrated embodiment, the motive flow is formed by a flow of non-potable water at a pressure in a range of from about 25.0 pounds per square inch (psi) to about 200.0 psi and a flow rate in a range of from about 1.0 gallons per minute to about 5 gallons per minute. However, in other embodiments, the motive flow can be formed from other mediums, at other pressures and at other flow rates.

Referring again to FIG. 8, the motive flow exits the jet assembly 18 and is infused into the slurry flow, thereby forming an infused slurry flow as characterized by direction arrows D. The infused slurry flow is conveyed downstream by the outlet pipe 28. Simultaneously, a header 80 is configured to carry a flow of raw, untreated water as characterized by direction arrow E. The outlet pipe 28 is in fluid communication with the header 80 such that the infused slurry flow is injected into, and mixes with, the flow of raw, untreated water in the header 80, thereby forming treated water as characterized by direction arrow F.

Referring again to FIGS. 5 and 6A, the cross-sectional area of the fifth internal passage 55 of the second jet segment 52 is about 0.15 square inches and the cross-sectional area of the second internal passage 32 of the second segment 14 is about 2.8 square inches. Accordingly, a jet assembly ratio can be calculated as the cross-sectional area of the fifth internal passage 55 of the second jet segment 52 divided by the cross-sectional area of the second internal passage 32 of the second segment 14. In the illustrated embodiment, the jet assembly ratio is about 0.05. While the illustrated embodiment provides a jet assembly ratio of about 0.05, it has been found that effective infusion of the motive flow into the slurry flow occurs with a jet assembly ratio in a range of from about 0.03 to about 0.10. Without being held to the theory, it is believed the jet assembly ratio is one measure providing for the efficiency of the infusion process of the motive flow into the slurry flow. In the event the jet assembly ratio is less than about 0.03, then the motive flow exiting the jet assembly 18 lacks sufficient volume to urge the slurry flow. In the event the jet assembly ratio is greater than 0.10, then the motive flow exiting the jet assembly provides unacceptable dilution of the slurry flow.

Referring again to the embodiment illustrated in FIG. 8, the slurry flow rate through the first segment 12 is about 11.6 gallons per minute (gpm) at about 34.00 pounds per square inch and the motive flow through the jet assembly 18 has a flow rate of about 3.6 gallons per minute at about 36.00 pounds per square inch. Accordingly, a motive flow pressure ratio can be calculated as the pressure of the motive flow slurry divided by the pressure of the slurry flow. In the illustrated embodiment, the motive flow pressure ratio is about 1.06. While the illustrated embodiment provides a jet assembly pressure ratio of about 1.06, it has been found that effective infusion of the motive flow into the slurry flow occurs with a jet assembly pressure ratio in a range of from about 1.00 to about 1.60. In the event the jet assembly pressure ratio is less than about 1.00, then the motive flow exiting the jet assembly 18 lacks sufficient pressure to urge the slurry flow. In the event the jet assembly pressure ratio is greater than 1.60, then the motive flow exiting the jet assembly provides unacceptable dilution of the slurry flow.

Referring again to FIG. 8, the axial infuser assembly 10 provides many benefits, although all benefits may not be present in all embodiments. First, since the axial infuser assembly 10 provides that the motive flow is flowing in the same parallel axial direction as the slurry flow, the slurry flow and the motive flow work together to achieve a desired penetration of the infused slurry flow into the raw, untreated water. Second, the motive flow provides sufficient fluid force to the infused slurry flow such that the infused slurry flow is able to overcome boundary pressure of the flowing raw, untreated water within the header 80. Third, the axial infuser assembly 10 eliminates the need for conventional back pressure infusers. Fourth, the axial infuser assembly 10 can be configured to closely maintain the desired concentration levels of the slurry flow. Fifth, the axial infuser assembly 10 can be configured to maintain the suspension of the elements and/or chemicals within the slurry flow. Finally, the axial infuser assembly 10 is configured to use the motive flow at pressures and flow rates that are significantly less than pressures and flow rates used by conventional back pressure systems.

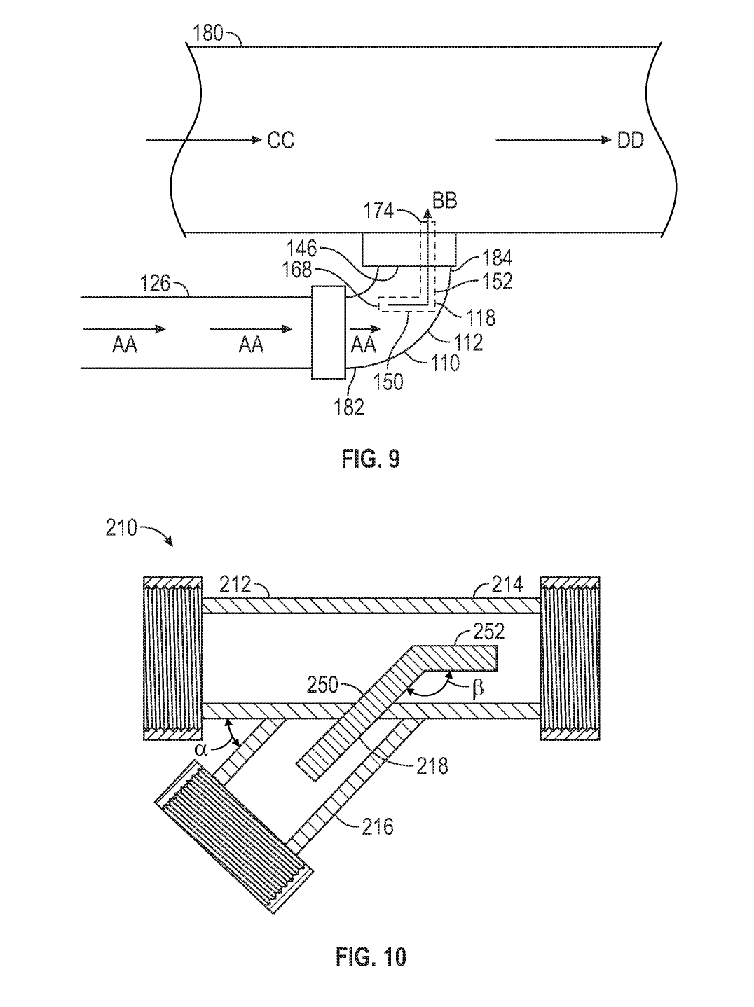

While the embodiment of the axial infuser assembly shown in FIGS. 1-8 illustrates the use of a slurry flow, it is within the contemplation of the axial infuser assembly that the elements and/or chemicals can be inserted into a header in a “dry” form, that is, without a liquid medium. In these embodiments, the jet assembly can be used to insert a gaseous medium, such as the non-limiting example of air, which is infused with the dry elements and/or chemicals. The mixture of the dry elements and/or chemicals and infused gaseous medium is subsequently injected into the header containing raw, untreated water. Referring now to FIG. 9, one non-limiting example of a dry injection system is illustrated. The dry injection system includes an axial infuser assembly 110 having a main segment 112 configured to support a jet assembly 118. In the illustrated embodiment, the jet assembly 118 is the same as, or similar to the jet assembly 18 described above and illustrated in FIGS. 1-8. However, in other embodiments, the jet assembly 118 can be different from the jet assembly 18.

Referring again to FIG. 9, the jet assembly 118 includes a first jet segment 150 and a second jet assembly 152 and the main segment 112 includes an internal wall 146. In the illustrated embodiment, the internal wall 146 is the same as, or similar to the internal wall 46 described above and illustrated in FIGS. 1-8. However, in other embodiments, the internal wall 146 can be different from the internal wall 46.

Referring again to FIG. 9, a first end 182 of the main segment 112 is connected to an inlet pipe 126 such that fluid communication is enabled therebetween. A second end 184 of the main segment 112 is connected to a header 180 in a manner such that the jet assembly 118 is in fluid communication with the header 180.

Referring again to FIG. 9, in operation the main segment 112 of the axial infuser assembly 110, connected to the inlet pipe 126, receives a flow of a gaseous medium infused (hereafter “infused gaseous medium”) with dry elements and/or chemicals from the inlet pipe 126, as characterized by direction arrows AA. The infused gaseous medium is configured for mixing with raw, untreated water as a purification treatment. The infused gaseous medium can have any desired concentration level of the elements and/or chemicals within the gaseous medium.

Referring again to FIG. 9, as the infused gaseous medium flows through the main segment 112, a portion of the infused gaseous medium contacts the internal wall 146 and is prevented from further flow. Another portion of the infused gaseous medium is received by an inlet jet aperture 168 and continues to flow through the jet assembly 118 as characterized by direction arrow BB. The infused gaseous medium continues to flow through the jet assembly 118 and exits the jet assembly 118 through an exit jet aperture 174.

Referring again to FIG. 8, simultaneously, the header 180 is configured to carry a flow of raw, untreated water as characterized by direction arrow CC. The infused gaseous medium is injected into, and mixes with, the flow of raw, untreated water in the header 180, thereby forming treated water as characterized by direction arrow DD.

Referring now to FIG. 10, another embodiment of an axial infuser assembly is shown generally at 210. The axial infuser assembly 210 includes a first segment 212, a second segment 214, a third segment 216 and a jet assembly 218. In the illustrated embodiment, the first segment 212 and the second segment 214 are the same as, or similar to the first segment 12 and the second segment 14 described above and illustrated in FIG. 5. This embodiment is characterized in that the third segment 216 forms an angle α with the first segment 212 and the angle α is less than 90°. In the embodiment illustrated in FIG. 10, the angle α is about 45°. However, in other embodiments, the angle α can be less than 45° or more than 45° and less than 90°.

Referring again to FIG. 10, a first segment 250 of the jet assembly 218 forms an angle β with a second segment 252 of the jet assembly 218 and the angle β is more than about 90°. In the embodiment illustrated in FIG. 10, the angle β is about 135°. However, in other embodiments, the angle β can be in a range of more than about 90° to about 180°.

Referring now to FIG. 6A, the jet assembly 18 includes discrete first and second jet segments 50, 52 connected together. However, it is within the contemplation of the axial infuser assembly that the jet assembly can have a different structure. Referring now to FIG. 6B, a second embodiment of a jet assembly is illustrated generally at 318. The jet assembly 318 is configured to extend from an internal wall and is further configured to convey the motive flow received in the third segment to the second internal passage of the second segment in a manner similar to the jet assembly 18 described above. The jet assembly 318 has a continuous segment 350 formed by an outer wall 351. In the illustrated embodiment, the continuous segment 350 has an arcuate shape. However, in other embodiments, the continuous segment 350 can have other shapes. The outer wall 351 of the continuous segment 350 defines an internal passage 354 extending the length of the continuous segment 350. In the illustrated embodiment, the continuous segment 350 forms a hollow structure having circular cross-sectional shape. In alternate embodiments, the continuous segment 350 can form other structures and can have a non-circular cross-sectional shape.

Referring again to FIG. 6B, the continuous segment 350 has a first end 360 and a second end 362. The first end 360 of the continuous segment 350 includes a first jet aperture 368 and the second end 362 of the continuous segment 350 includes a second jet aperture 370. The first and second jet apertures 368, 370 are in fluid communication with the internal passage 354 such that a motive flow received by the first jet aperture 368 can flow through the continuous segment 350 and exit the second jet aperture 370.

Referring again to FIG. 6A, the internal passage 354 has a diameter D5 and a circular cross-sectional shape thereby forming a cross-sectional area. In the illustrated embodiment, the diameter D5, circular cross-sectional shape of the internal passage 354, and the cross-sectional area of the internal passage 354 are the same as, or similar to the diameters D3, D4, circular cross-sectional shape of the internal passages 54, 55, and the cross-sectional area of the internal passages 54, 55 shown in FIG. 6A and described above. However, in other embodiments, the diameter D5, circular cross-sectional shape of the internal passage 354, and the cross-sectional area of the internal passage 354 can be different from the diameters D3, D4, circular cross-sectional shape of the internal passages 54, 55, and the cross-sectional area of the internal passages 54, 55.

Referring again to FIG. 6B, the second jet aperture 370 of the jet assembly 318 is radially centered about longitudinal axis JB-JB. Referring now to FIG. 5, as discussed above the first and second internal passages 22, 32 of the first and second segments 12, 14 are radially centered about longitudinal axis SS-SS. With the jet assembly 318 in an installed position, the longitudinal axis JB-JB and the longitudinal axes SS-SS are arranged to be substantially parallel, such that the motive flow exiting the jet assembly 318 flows in the same direction with the slurry flow in the second segment 14 of the axial infuser assembly 10. As the motive flow flows in the same direction with the slurry flow in the second segment 14 of the axial infuser assembly 10, the motive flow is infused into the slurry flow.

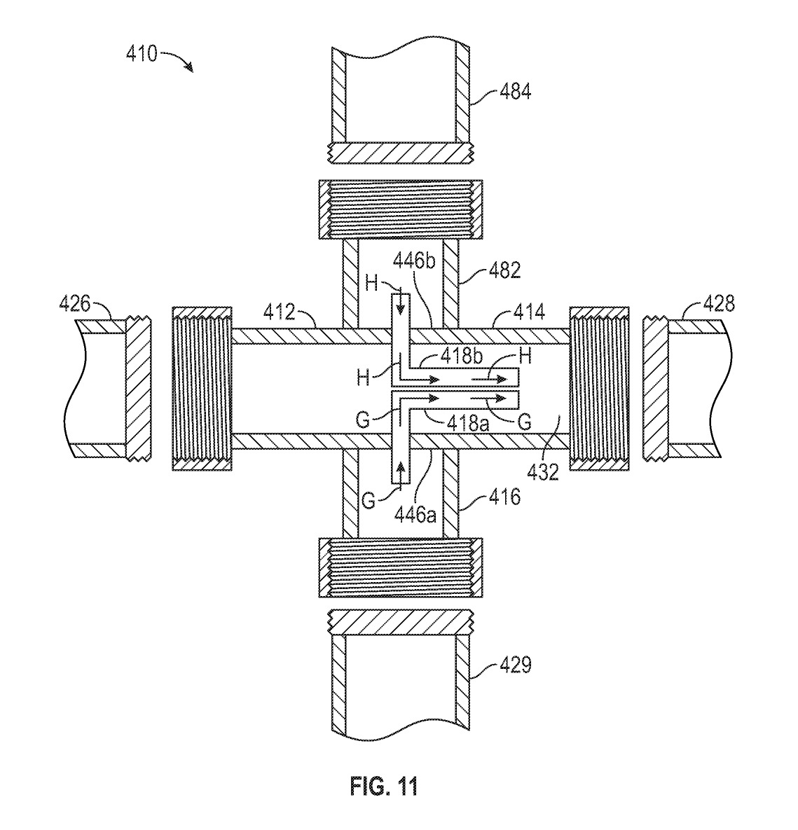

Referring now to FIG. 11, another embodiment of an axial infuser assembly is shown generally at 410. The axial infuser assembly 410 is configured to urge a slurry flow, formed from elements and/or chemicals and mixed with a plurality of flowable mediums, into flowing raw, untreated water. The slurry flow is configured to mix with the flowing raw, untreated water such that the elements and/or chemicals within the slurry mix with the flowing raw, untreated water and have the desired purifying effect. The axial infuser assembly 410 includes a first segment 412 connected to a first inlet pipe 426, a second segment 414 connected to an outlet pipe 428, a third segment 416 connected to a motive flow inlet pipe 429 and a fourth segment 482 connected to a second inlet pipe 484. In the illustrated embodiment, the first segment 412, first inlet pipe 426, second segment 414, outlet pipe 428, third segment 416 and motive flow inlet pipe 429 are the same as the first segment 12, first inlet pipe 26, second segment 14, outlet pipe 28, third segment 16 and motive flow inlet pipe 29 described above and shown in FIG. 5. However, in other embodiments, the first segment 412, first inlet pipe 426, second segment 414, outlet pipe 428, third segment 416 and motive flow inlet pipe 429 can be different than the first segment 12, first inlet pipe 26, second segment 14, outlet pipe 28, third segment 16 and motive flow inlet pipe 29.

Referring again to the embodiment shown in FIG. 11, the fourth segment 482 has the same structure, or a similar structure, as the first inlet pipe 426. In alternate embodiments, the fourth segment 482 can have a different structure than the first inlet pipe 426.

Referring again to FIG. 11, the axial infuser assembly 410 includes a first jet assembly 418a and a second jet assembly 418b. The first jet assembly 418a extends from a first internal wall 446a in the third segment 416 and the second jet assembly 418b extends from a second internal wall 446b in the fourth segment 482. The internal walls 446a, 446b are configured to contain motive flows received in the third and fourth segments 416, 482.

Referring again to the embodiment illustrated in FIG. 11, the jet assemblies 418a, 418b are the same as the jet assembly 18 described above and shown in FIG. 5. However, in other embodiments, the jet assemblies 418a, 418b can be different from the jet assembly 18. The jet assembly 418a is configured to convey the motive flow received in the third segment 416 to an internal passage 432 of the second segment 414 as represented by direction arrows G. In a similar manner, the jet assembly 418b is configured to convey the motive flow received in the fourth segment 482 to an internal passage 432 of the second segment 414 as represented by direction arrows H. Advantageously, the slurry flow flowing through the first and second segments 412, 414 can be impacted by a plurality of motive flows G, H.

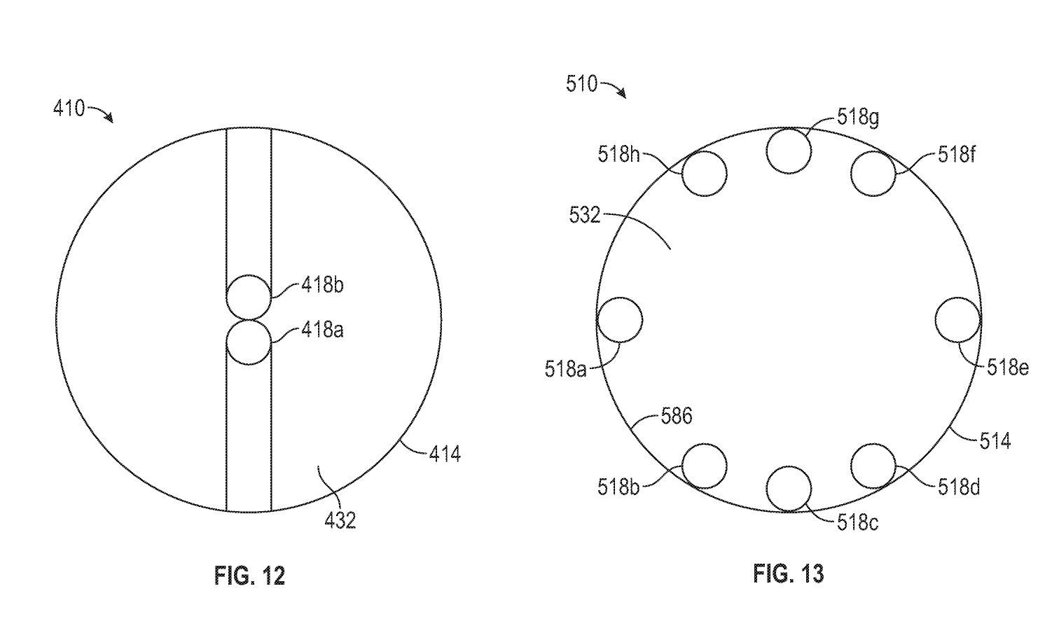

Referring now to FIG. 12, a schematic view of the outlet end of the second segment 414 of the axial infuser assembly 410 is illustrated. In the illustrated embodiment, the jet assemblies 418a, 418b are positioned proximate each other and are generally centered within the internal passage 432 formed within the second segment 414. However, it is within the contemplation of the axial infuser assembly that the jet assemblies can have different positioning within the internal passage formed by the second segment. Referring now to FIG. 13, another embodiment of the axial infuser assembly is shown schematically at 510.

Referring again to FIG. 13, a plurality of jet assemblies 518a-518h are positioned in a spaced apart arrangement within the internal passage 532 formed within the second segment 514. In the illustrated embodiment, the jet assemblies are positioned radially proximate an internal wall 586 formed by the second segment 514. However, such positioning is optional and not required for operation of the plurality of jet assemblies 518a-518h. While a quantity of eight (8) jet assemblies are illustrated, it should be appreciated that any desired quantity of jet assemblies can be used. It is also within the contemplation of the axial infuser assembly that a combination of centrally positioned jet assemblies and radially positioned jet assemblies can be used.

While the axial infuser assembly has been described above in context to the treatment of flowing raw, untreated water in a water treatment facility, it is within the contemplation of the axial infuser assembly that other applications are possible. Non-limiting examples of other applications include the flow of storm water in storm pipes, the flow of water exiting a filter system in a pool, the flow of water from a field tile discharge, the flow of water exiting a sump pump and the like. It is contemplated that the axial infuser assembly has application in situations where a flow of a liquid medium must overcome a barrier pressure of a flowing liquid medium.

The principle and mode of operation of the axial infuser assembly has been described in certain embodiments. However, it should be noted that the axial infuser assembly may be practiced otherwise than as specifically illustrated and described without departing from its scope.

What is claimed is:

1. An axial infuser assembly configured for use in a water treatment system, the axial infuser assembly comprising:
a first segment configured for fluid communication with a first inlet pipe, the first segment further configured to receive a slurry flow;
a second segment in fluid communication with the first segment and configured for connection to an outlet pipe, the second segment configured to receive the slurry flow from the first segment;
a third segment connected to the first and second segments and configured for connection to a second inlet pipe, the third segment configured to receive a motive flow; and
a jet assembly in fluid communication with the third segment and configured to convey the motive flow in the third segment to the slurry flow;
wherein the motive flow exiting the jet assembly is configured to infuse with the slurry flow and further configured to urge the slurry flow into flowing raw, untreated water.

2. The axial infuser assembly of claim 1, wherein the first inlet pipe is radially centered about a first longitudinal axis and a second jet segment is radially centered about a second longitudinal axis, and wherein the first and second longitudinal axes are arranged in a parallel orientation.

3. The axial infuser assembly of claim 1, wherein the jet assembly includes a first jet segment connected to a second jet segment.

4. The axial infuser assembly of claim 1, wherein the jet assembly extends from an internal wall configured to block a portion of the motive flow.

5. The axial infuser assembly of claim 1, wherein a ratio of the cross-sectional area of an internal passage of the jet assembly to the cross-sectional area of an internal passage of an outlet pipe is in a range of about 0.03 to about 0.10.

6. A method of operating an axial infuser assembly configured for use in a water treatment system, the method comprising the steps of:
receiving a slurry flow within an axial infuser assembly;
receiving a motive flow within the axial infuser assembly;
injecting the motive flow into the slurry flow with a jet assembly positioned within the axial infuser assembly such that the motive flow is infused into the slurry flow; and
conveying the combination of the slurry flow and the motive flow downstream for injection of the combination of the slurry flow and the motive flow into raw, untreated water.

7. The method of claim 6, including the step of arranging a first longitudinal axis of a first inlet pipe to be parallel with a longitudinal axis of a second jet segment.

8. The method of claim 6, including the step of connecting a first jet segment of the jet assembly with a second jet segment.

9. The method of claim 6, including the step of extending the jet assembly from an internal wall configured to block a portion of the motive flow.

10. The method of claim 6, wherein a ratio of a cross-sectional area of an internal passage of the jet assembly and a cross-sectional area of an internal passage of an outlet pipe is in a range of about 0.03 to about 0.10.

11. A water treatment system incorporating an axial infuser assembly, the water treatment system comprising;
a first inlet pipe configured to convey a slurry flow;
a second inlet pipe configured to convey a motive flow;
an axial infuser assembly in fluid communication with the first inlet pipe and the second inlet pipe, the axial infuser assembly further configured to receive the slurry flow from the first inlet pipe and a motive flow from the second inlet pipe, the axial infuser assembly including a jet assembly in fluid communication with the second inlet pipe and configured to convey the motive flow to the slurry flow;
an outlet pipe configured to receive the slurry flow and the motive flow exiting the axial infuser assembly and convey the slurry flow and the motive flow downstream; and
a header configured to receive the slurry flow and the motive flow exiting the outlet pipe and mix the slurry flow and the motive flow with flowing raw, untreated water.

12. The water treatment system of claim 11, wherein the first inlet pipe is radially centered about a first longitudinal axis and a second jet segment is radially centered about a second longitudinal axis, and wherein the first and second longitudinal axes are arranged in a parallel orientation.

13. The axial infuser assembly of claim 11, wherein the jet assembly includes a first jet segment connected to a second jet segment.

14. The axial infuser assembly of claim 11, wherein the jet assembly extends from an internal wall configured to block a portion of the motive flow.

15. The axial infuser assembly of claim 11, wherein a ratio of a cross-sectional area of an internal passage of the jet assembly and a cross-sectional area of an internal passage of an outlet pipe is in a range of about 0.03 to about 0.10.

16. A method of operating a water treatment system incorporating an axial infuser assembly, the method comprising the steps of:
forming a slurry flow having a desired concentration of elements suspended in a flowable medium;
conveying the slurry flow to an axial infuser assembly;
conveying a motive flow to the axial infuser assembly, the motive flow having a desired pressure and flow rate;
injecting the motive flow into the slurry flow with a jet assembly positioned within the axial infuser assembly such that the motive flow is infused into the slurry flow;
conveying the combination of the slurry flow and the motive flow with an outlet pipe to a header; and
injecting the combination of the slurry flow and the motive flow into raw, untreated water flowing in the header.

17. The method of claim 16, including the step of arranging a first longitudinal axis of a first inlet pipe to be parallel with a longitudinal axis of a second jet segment.

18. The method of claim 16, including the step of connecting a first jet segment of the jet assembly with a second jet segment.

19. The method of claim 16, including the step of extending the jet assembly from an internal wall configured to block a portion of the motive flow.

20. The method of claim 16, wherein a ratio of a cross-sectional area of an internal passage of the jet assembly and a cross-sectional area of an internal passage of an outlet pipe is in a range of about 0.03 to about 0.10.
